(19) United States
(12) Patent Application Publication
(10) Pub. No.: US 2023/0257218 A1
(43) Pub. Date: Aug. 17, 2023

(54) FABRICATION PLATFORM

(71) Applicant: SHENZHEN CHINA STAR OPTOELECTRONICS SEMICONDUCTOR DISPLAY TECHNOLOGY CO., LTD., Shenzhen (CN)

(72) Inventors: Xin Zhang, Shenzhen (CN); Hongyuan Xu, Shenzhen (CN); Jia Li, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 17/419,034

(22) PCT Filed: Dec. 29, 2020
(86) PCT No.: PCT/CN2020/140511

§ 371 Date: Apr. 24, 2023

(30) Foreign Application Priority Data
Feb. 21, 2020 (CN) 202010108267.8

(51) Int. Cl. B65G 49/06; B65G 49/04

(52) U.S. Cl. CPC B65G 49/067; B65G 49/0427; B65G 49/061; B65G 2249/045

(57) ABSTRACT

A fabrication platform used for production lines of a display panel is provided. The fabrication platform includes: a jig, wherein the jig is configured to carry a glass substrate, and a plurality of via holes are defined on the jig; and an adsorption device, wherein the adsorption device includes a plurality of suction pads, the suction pads are disposed on a side of the jig away from the glass substrate and are disposed corresponding to the via holes, and the suction pads adsorb the glass substrate on the jig through the via holes. The provided fabrication platform effectively improves yield rate of the glass substrate in welding processes.

### FIELD OF INVENTION

The present application relates to the field of display panels and specifically relates to a fabrication platform.

### DESCRIPTION OF PRIOR ART

Performing thin film transistor (TFT) processes on glass substrates to drive mini-light emitting diodes (mini-LEDs) is a new field. However, because the glass substrates are softer and more fragile compared to printed circuit boards (PCBs), in processes of performing surface mounted technology (SMT), deformation easily occurs and causes displacement or cracks to occur on the glass substrates. Therefore, a transmission jig is needed.

However, jigs in prior art often cause relative displacement between the glass substrates and the jigs due to pressure during stencil printing stages, causing the glass substrates to be scratched or short-circuited.

### SUMMARY OF INVENTION

### Technical Problem

Embodiments of the present application provide a fabrication platform, which aims to solve a problem of glass substrates being scratched or short-circuited due to relative displacement between jigs and glass substrates during fabrication of display panels in prior art.

### Solution to Technical Problem

### Technical Solution

The present application provides a fabrication platform used for production lines of a display panel. Wherein, the fabrication platform includes:

a jig, wherein the jig is configured to carry a glass substrate, and a plurality of via holes are defined on the jig; and

an adsorption device, wherein the adsorption device includes a plurality of suction pads, the suction pads are disposed on a side of the jig away from the glass substrate and are disposed corresponding to the via holes, and the suction pads adsorb the glass substrate on the jig through the via holes.

Furthermore, the jig is a grooved structure, and the glass substrate is disposed in an interior of the groove.

Furthermore, the grooved structure includes a concave section and a convex section, and a shape of a surface of the glass substrate contacted to the concave section is same as a shape of the concave section.

Furthermore, a plurality of via-hole regions are defined on the jig, and a plurality of via holes are defined in each of the via-hole regions.

Furthermore, a plurality of via holes in the via-hole regions are distributed evenly in the via-hole regions.

Furthermore, the plurality of via-hole regions are distributed along edges of the jig.

Furthermore, intervals between the plurality of via-hole regions are same.

Furthermore, a number of the via-hole regions is four, and the via-hole regions are distributed at positions of four corners of the jig.

Furthermore, a number of the via-hole regions is four, and the four via-hole regions are respectively defined at central positions of edges of the jig.

Furthermore, the suction pads are elastic.

Furthermore, the suction pads are made of an elastic material.

Furthermore, the elastic material is rubber, silica gel, or poly(vinyl fluoride).

Furthermore, the adsorption device includes an air extracting appliance and vacuum tubes, the suction pads are connected to the air extracting appliance through the vacuum tubes, the air extracting appliance is configured to remove at least part of gas in the suction pads to allow the glass substrate to be adsorbed on the jig through the via holes.

Furthermore, the via holes are circular holes, rectangular holes, or triangular holes.

Furthermore, a diameter of the via holes ranges from 0.1 mm to 25 mm.

Furthermore, the suction pads completely cover the via holes.

Furthermore, areas of the suction pads are greater than or equal to cross sectional areas of the via holes.

Furthermore, shapes of different via holes are different.

Furthermore, sizes of different via holes are different.

Furthermore, the suction pads and the via holes are disposed correspondingly one-to-one, and a number of the suction pads and a number of the via holes are same.

The fabrication platform provided by embodiments of the present application includes the jig and the adsorption device. The plurality of via holes are defined on the jig. The adsorption device includes the plurality of suction pads. The suction pads are disposed corresponding to the via holes. The adsorption device adsorbs the glass substrate on the jig through the via holes. Through this configuration, the displacement of glass substrates relative to the jigs during welding processes, which causes the glass substrates to be scratched and short-circuited or a welding material to shift, can be prevented, thereby effectively improving yield rate of the glass substrate in the welding process.

### Beneficial Effect of the Invention

### Advantageous Effect

The fabrication platform provided by embodiments of the present application includes the jig and the adsorption device. The plurality of via holes are defined on the jig. The adsorption device includes the plurality of suction pads. The suction pads are disposed corresponding to the via holes. The adsorption device adsorbs the glass substrate on the jig through the via holes. Through this configuration, the displacement of glass substrates relative to the jigs during welding processes, which causes the glass substrates to be scratched and short-circuited or a welding material to shift, can be prevented, thereby effectively improving yield rate of the glass substrate in the welding process.

### BRIEF DESCRIPTION OF DRAWINGS OF THE INVENTION

### Description of Drawings

The technical solutions and other advantageous effects of the present invention will be apparent with reference to the following accompanying drawings and detailed description of embodiments of the present application.

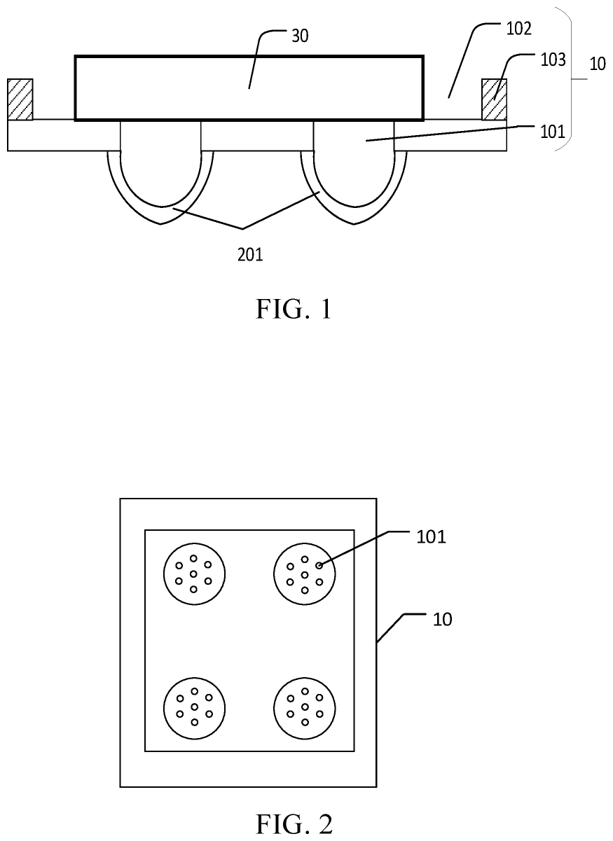

FIG. 1 is a lateral view of one embodiment of a fabrication platform provided by the present application.

FIG. 2 is a top view of one embodiment of the fabrication platform provided by the present application.

### EMBODIMENTS OF THE INVENTION

### Detailed Description of Embodiments

The technical solutions in the embodiments of the present application are clearly and completely described in the following with reference to the accompanying drawings in the embodiments of the present application. Obviously, the described embodiments are only part of the embodiments of the present application, but are not all embodiments of the present application. All other embodiments obtained by those skilled in the art based on the embodiments of the present application without creative efforts are within the scope of the present application.

In the description of the present application, it is to be understood that the orientation or positional relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise” etc. is based on the orientation or positional relationship shown in the accompanying figures, which is merely for the convenience for describing of the present application and for the simplification of the description, and is not intended to indicate or imply that the indicated devices or elements have a specific orientation or is constructed and operated in a specific orientation. Therefore, it should not be understood as a limitation on the present application. Moreover, the terms “first” and “second” are used for descriptive purposes only and are not to be understood as indicating or implying relative importance or implicitly indicating the number of the indicated technical characteristics. Therefore, the characteristics defined by “first” or “second” may include one or more of the described characteristics either explicitly or implicitly. In the description of the present application, the meaning of “a plurality” is two or more unless clearly and specifically defined otherwise.

In the description of the present application, unless specified or limited otherwise, terms “mounted,” “connected,” “coupled,” and the like are used in a broad sense, and may include, for example, fixed connections, detachable connections, or integral connections; may also be mechanical or electrical connections or may be communication between each other; may also be direct connections or indirect connections via intervening structures; may also be inner communications of two elements or may be a relationship of interaction between two elements. For persons skilled in the art in this field, the specific meanings of the above terms in the present application can be understood with specific cases.

In the present application, unless expressly specified or limited otherwise, a first feature is “on” or “beneath” a second feature may include that the first feature directly contacts the second feature and may also include that the first feature does not directly contact the second feature. Furthermore, a first feature “on”, “above”, or “on top of”, a second feature may include an embodiment in which the first feature is right “on”, “above”, or “on top of” the second feature and may also include that the first feature is not right “on”, “above”, or “on top of” the second feature, or just means that the first feature has a sea level elevation higher than the sea level elevation of the second feature. While first feature “beneath”, “below”, or “on bottom of” a second feature may include that the first feature is “beneath”, “below”, or “on bottom of” the second feature and may also include that the first feature is not right “beneath”, “below”, or “on bottom of” the second feature, or just means that the first feature has a sea level elevation lower than the sea level elevation of the second feature.

The following disclosure provides many different embodiments or examples for implementing the different structures of the present application. In order to simplify the disclosure of the present application, the components and configurations of the specific examples are described below. Of course, they are merely examples and are not intended to limit the present application. In addition, the present application may repeat reference numerals and/or reference numerals in different examples, which are for the purpose of simplicity and clarity, and do not indicate the relationship between the various embodiments and/or arrangements discussed. Moreover, the present application provides embodiments of various specific processes and materials, but one of ordinary skill in the art will recognize the use of other processes and/or the use of other materials.

One embodiment of the present application provides a fabrication platform used for production lines of a display panel. The fabrication platform includes:

a jig, wherein the jig is configured to carry a glass substrate, and a plurality of via holes are defined on the jig; and

an adsorption device, wherein the adsorption device includes a plurality of suction pads, the suction pads are disposed on a side of the jig away from the glass substrate and are disposed corresponding to the via holes, and the suction pads adsorb the glass substrate on the jig through the via holes.

The fabrication platform provided by embodiments of the present application includes the jig and the adsorption device. The plurality of via holes are defined on the jig. The adsorption device includes the plurality of suction pads. The suction pads are disposed corresponding to the via holes. The adsorption device adsorbs the glass substrate on the jig through the via holes. Through this configuration, the displacement of glass substrates relative to the jigs during welding processes, which causes the glass substrates to be scratched and short-circuited or a welding material to shift, can be prevented, thereby effectively improving yield rate of the glass substrate in the welding process.

Illustrated in FIG. 1 is a lateral view of one embodiment of the fabrication platform provided by the present application. The fabrication platform includes: a jig 10, wherein, the jig 10 is configured to carry the glass substrate 30, which allows the glass substrate 30 to be better moved on production lines and to allow follow-up manufacturing processes of a display panel to be performed on the glass substrate 30, and a plurality of via holes 10 are defined on the jig 10; an adsorption device 20, wherein the adsorption device 20 includes a plurality of suction pads 201, the suction pads 201 are disposed on a side of the jig 10 away from the glass substrate 30 and are disposed corresponding to the via holes 101, and the suction pads 201 adsorb the glass substrate 30 on the jig 10 through the via holes 101.

Specifically, the jig 10 is a grooved structure, and the grooved structure includes a concave section 102 and a convex section 103. The glass substrate 30 is disposed in an interior of the groove structure. Specifically, a size of the glass substrate 30 can be equal to a size of the concave section 102, i.e., the glass substrate 30 is completely embedded in the concave section 102. In other embodiment, a shape of a surface of the glass substrate 30 contacted to the concave section 102 is same as a shape of the concave section 102, and a thickness of the glass substrate 30 can be greater than a height of coating 102. This configuration is more convenient for taking the glass substrate 30.

In one specific embodiment on the present invention, a concave section 102 of the grooved structure can be a rectangular parallelepipedal structure. At this time, the glass substrate 30 can also be a rectangular parallelepipedal structure, and a cross sectional width of the glass substrate 30 is less than or equal to a cross sectional width of the concave section 102. The glass substrate 30 can be completely disposed in the concave section 102. Furthermore, when the cross sectional width of the glass substrate 30 is equal to the cross sectional width of concave section 103, a lateral surface of the glass substrate 30 is contacted with the convex section 103, so a gap existing between the glass substrate 30 and the lateral surface of the jig 10 is prevented, wherein the gap can cause air to enter the suction pads 201 from the gap and to make a function of the suction pads 201 to be failed.

Illustrated in FIG. 2 is a top view of one embodiment of the fabrication platform provided by the present application. A plurality of via-hole regions 104 are defined on the jig 10. These via-hole regions 104 can be distributed along edges of the jig 10 or disposed in an internal region of the jig 10. Specifically, there are the plurality of via-hole regions 104, and intervals between the plurality of via-hole regions 104 are same. In this way, the plurality of via-hole regions 104 are allowed to be evenly distributed along the edges of the jig 10. Furthermore, the plurality of via holes 101 are defined in each of the via-hole regions 104, and the plurality of via holes 101 are distributed evenly in the via-hole regions 104. As the via-hole regions 104 are distributed evenly, and via holes 101 in the via-hole regions 104 are also distributed evenly, stress on the glass substrate 30 is even, and problems such as cracking of the glass substrate 30 due to uneven stress are prevented.

In one specific embodiment of the present invention, a number of the via-hole regions 104 is four, and the via-hole regions 104 are distributed at positions of four corners of the jig 10. Of course, the four via-hole regions 104 can be respectively defined at central positions of edges of the jig 10. This configuration allows the stress on the glass substrate 30 to be even, which prevents cracking of the glass substrate 30 due to uneven force.

In other embodiment of the present invention, the via holes 101 can be directly defined on the jig 10, and the via holes 101 are distributed evenly. Specifically, the via holes 101 can be defined on the jig 10 according to a matrix distribution manner.

In the aforesaid embodiments, the via holes 101 can be circular holes, rectangular holes, or triangular holes.

In one embodiment of the present application, the adsorption device 20 includes the plurality of suction pads 201. These suction pads 201 and the via holes 101 are disposed correspondingly one-to-one, i.e., a number of the suction pads 201 and a number 101 of the via holes are same.

In the aforesaid embodiments, the suction pads 201 can be made of an elastic material. After the suction pads 201 are covered on the via holes 101, pressure is artificially applied to the suction pads 201 to remove at least part of gas in the suction pads 201, so that internal pressure of the suction pads 201 is lowered, and atmospheric pressure outside the suction pads 201 remains unchanged. Therefore, a pressure difference is formed between an inside and an outside of the suction pads 201, and the suction pads 201 are firmly adsorbed at positions of the via holes 101. Because the suction pads 201 are contacted to the glass substrate 30 at the positions of the via holes 101, the suction pads 201 adsorbs the glass substrate 30 on the jig 10 through the via holes 101. In this way, relative displacement between the glass substrate 30 and the jig 10 causing scratches or short circuit on the glass substrate 30 can be prevented.

In the aforesaid embodiments, the elastic material can be rubber, silica gel, or polyvinyl chloride (PVC). The suction pads 201 made of the elastic material have a relatively great tearing force, which is not prone to cracking and has low manufacturing cost.

In some other embodiments of the present application, the adsorption device 20 can further include an air extracting appliance and vacuum tubes, and the suction pads are connected to the air extracting appliance through the vacuum tubes, i.e., one end of the vacuum tubes is connected to the suction pads, and another end of the vacuum tubes is connected to the air extracting appliance. The air extracting appliance is configured to remove at least part of gas in the suction pads 201, which allows the suction pads 201 to adsorb the glass substrate 30 on the jig 10 through the via holes 101.

In one embodiment of the present invention, a volume of gas in an interior of the suction pads 201 can be adjusted to adjust pressure difference between the inside and the outside of the suction pads, thereby adjusting adsorption effect of the suction pads 201 to the glass substrate 30.

Preferably, the gas inside the suction pads 201 can be completely removed, which allows the pressure difference between the inside and outside of the suction pads 201 to be maximized and the adsorption effect to be the best.

In one embodiment of the present application, the suction pads 201 need to completely cover the via holes 101, that is, areas of the suction pads 201 are greater than or equal to cross sectional areas of the via holes 101. Furthermore, a diameter of the via holes 101 ranges from 0.1 mm to 25 mm. Specifically, the diameter of the via holes 101 can be 0.1 mm, 5 mm, 10 mm, 15 mm, or 25 mm. Shapes of different via holes 101 can be different, and sizes of different via holes 101 can also be different. Preferably, shapes of different via holes 101 are same, and sizes of different via holes 101 are same. In this way, manufacturing cost of manufacturing this kind of the jig 10 is lower.

In the above embodiments, the description of each embodiment has its emphasis, and for some embodiments that may not be detailed, reference may be made to the relevant description of other embodiments.

The fabrication platform provided by the embodiments of present application is described in detail above. This article uses specific cases for describing the principles and the embodiments of the present disclosure, and the description of the embodiments mentioned above is only for helping to understand the method and the core idea of the present disclosure. It should be understood by those skilled in the art, that it can perform changes in the technical solution of the embodiments mentioned above, or can perform equivalent replacements in part of technical characteristics, and the changes or replacements do not make the essence of the corresponding technical solution depart from the scope of the technical solution of each embodiment of the present disclosure.

What is claimed is:

1. A fabrication platform used for production lines of a display panel, comprising:
a jig, wherein the jig is configured to carry a glass substrate, and a plurality of via holes are defined on the jig; and
an adsorption device, wherein the adsorption device comprises a plurality of suction pads, the suction pads are disposed on a side of the jig away from the glass substrate and are disposed corresponding to the via holes, and the suction pads adsorb the glass substrate on the jig through the via holes.

2. A fabrication platform as claimed in claim 1, wherein the jig is a grooved structure, and the glass substrate is disposed in an interior of the groove.

3. The fabrication platform as claimed in claim 2, wherein the grooved structure comprises a concave section and a convex section, and a shape of a surface of the glass substrate contacted to the concave section is same as a shape of the concave section.

4. The fabrication platform as claimed in claim 1, wherein a plurality of via-hole regions are defined on the jig, and the plurality of via holes are defined in each of the via-hole regions.

5. The fabrication platform as claimed in claim 4, wherein the plurality of via holes in the via-hole regions are distributed evenly in the via-hole regions.

6. The fabrication platform as claimed in claim 4, wherein the plurality of via-hole regions are distributed along edges of the jig.

7. The fabrication platform as claimed in claim 6, wherein intervals between the plurality of via-hole regions are same.

8. The fabrication platform as claimed in claim 4, wherein a number of the via-hole regions is four, and the via-hole regions are distributed at positions of four corners of the jig.

9. The fabrication platform as claimed in claim 4, wherein a number of the via-hole regions is four, and the four via-hole regions are respectively defined at central positions of edges of the jig.

10. The fabrication platform as claimed in claim 1, wherein the suction pads are elastic.

11. The fabrication platform as claimed in claim 10, wherein the suction pads are made of an elastic material.

12. The fabrication platform as claimed in claim 11, wherein the elastic material is rubber, silica gel, or poly(vinyl fluoride).

13. The fabrication platform as claimed in claim 1, wherein the adsorption device comprises an air extracting appliance and vacuum tubes, the suction pads are connected to the air extracting appliance through the vacuum tubes, and the air extracting appliance is configured to remove at least part of gas in the suction pads to allow the glass substrate to be adsorbed on the jig through the via holes.

14. The fabrication platform as claimed in claim 1, wherein the via holes are circular holes, rectangular holes, or triangular holes.

15. The fabrication platform as claimed in claim 14, wherein a diameter of the via holes ranges from 0.1 mm to 25 mm.

16. The fabrication platform as claimed in claim 1, wherein the suction pads completely cover the via holes.

17. The fabrication platform as claimed in claim 15, wherein areas of the suction pads are greater than or equal to cross sectional areas of the via holes.

18. The fabrication platform as claimed in claim 1, wherein shapes of different via holes of the plurality of via holes are different.

19. The fabrication platform as claimed in claim 1, wherein sizes of different via holes of the plurality of via holes are different.

20. The fabrication platform as claimed in claim 1, wherein the suction pads and the via holes are disposed correspondingly one-to-one, and a number of the suction pads and a number of the via holes are same.
